(19) United States
(12) Patent Application Publication
(10) Pub. No.: US 2012/0034007 A1
(43) Pub. Date: Feb. 9, 2012

(54) SHEET MOISTURIZING DEVICE AND IMAGE FORMING SYSTEM USING THE SAME

(75) Inventor: Masashi Kougami, Saitama-shi (JP)

(73) Assignee: KONICA MINOLTA BUSINESS TECHNOLOGIES, INC., Tokyo (JP)

(21) Appl. No.: 13/189,711

(22) Filed: Jul. 25, 2011

(30) Foreign Application Priority Data
Aug. 9, 2010 (JP) JP2010-178408

(51) Int. Cl. G03G 15/00

(52) U.S. Cl. 399/361

(57) ABSTRACT

A sheet moisturizing device including paired moisturizing rollers, which are configured to be in contact with each other and to apply liquids onto a recording sheet while nipping to convey the recording sheet, wherein the paired moisturizing rollers are configured to include a mandrel, and a moisturizing layer which is formed on the mandrel and is formed of a porous body carrying independent cells which are not interconnected with each other, and a liquid supplying member which is configured to supply the liquid onto surfaces of the paired moisturizing rollers.

### CROSS REFERENCE TO RELATED APPLICATION

This application is based on Japanese Patent Application No. 2010-178408 filed on Aug. 9, 2010 with the Japanese Patent Office, the entire content of which is hereby incorporated by reference.

### TECHNICAL FIELD

The present invention relates to a sheet moisturizing device and an image forming system using the same device.

### BACKGROUND OF THE INVENTION

In image forming apparatuses using the electro-photographic method, toner images, applied onto a recording sheet, are fixed by heat. However, when the heat is applied onto the sheet, water is evaporated from the sheet, whereby the distribution of water content in the sheet becomes heterogeneous, so that the sheet curves.

In order to prevent the recording sheet, on which the image was formed, from curving, sheet moisturizing technologies to apply water to said recording sheet have been developed. Concerning these sheet moisturizing technologies, it is necessary that the water is evenly applied on the total surface of the recording sheet, for which well known are water applying technologies to evenly moisturize the sheet, as shown in Patent Documents 1 (Unexamined Japanese Patent Application 2006-8282) and 2 (Unexamined Japanese Patent Application 2009-234679).

In Patent Document 1, a sheet moisturizing device is disclosed, in which a recording sheet is nipped to be conveyed by paired moisturizing rollers including a porous layer, whereby the recording sheet can be moisturized.

In Patent Document 2, another sheet moisturizing device is disclosed, in which a recording sheet is nipped to be conveyed by paired moisturizing rollers including a solid rubber layer, which is not a porous roller, whereby the recording sheet can be moisturized.

In order to continuously apply the water by the paired moisturizing rollers onto the recoding sheets, which are being conveyed at a high speed of 100 sheets/minute, it is necessary that the moisturizing rollers are configured to hold sufficient volume of water. Accordingly, as an example, with a metallic roller, which carries the water only on its surface, it is very difficult to evenly apply a sufficient volume of water onto the recording sheet.

Concerning Patent Document 1, the moisturizing roller, formed of a porous roller, is used so that the water can be carried within the porous layer, whereby the water is squeezed out of the porous layer, and is applied to the recording sheet.

In the moisturizing method using the porous roller, a volume of water, to be applied to the recording sheet, is averaged by squeezing the water from the moisturizing roller, so that uniform moisturizing can be conducted. Further, since a large volume of water can be kept in the moisturizing roller, a large volume of water can be applied to the recording sheet. However, in the moisturizing method for squeezing the water from the porous roller, while the moisturizing process is conducted onto a large number of recording sheets, various problems are adversely generated as detailed below, which are beyond the expectation.

Firstly listed is clogging within the porous roller.

In the moisturizing process, foreign particles, such as paper powder, are separated from the recording sheets, and fly onto the surface of the moisturizing roller, which can be removed when the moisturizing roller is washed. However, concerning the moisturizing roller, formed of a porous body, the foreign particles are introduced into the porous body, by a nipping pressure at a moisturizing nip portion, structured of paired moisturizing rollers, whereby the foreign particles clog the porous body, and accumulate in the porous body. Due to clogging of the porous body, the moisturizing ability of the moisturizing roller tends to decrease, which results in a rapid malfunction of the moisturizing device.

Secondarily to be listed is a problem that makes it is difficult to conduct uniformed moisturizing to the recording sheet.

The nipping pressure, at the moisturizing nip portion formed of paired moisturizing rollers, is not constant. Due to the passage of working time, the nipping pressure is decreased, and the change of nipping pressure cannot be averted. When the nipping pressure changes, the volume of water to be squeezed out from the moisturizing roller also changes, so that uneven moisturizing of the recording sheet is to be conducted.

Accordingly, it is understood that the moisturizing method, using the water squeezing out of the porous roller, is problematic.

In Patent Document 2, a moisturizing layer, formed of a solid rubber, is used as the moisturizing roller.

In the moisturizing method using the solid rubber of Patent Document 2, the problems, generated by the method using the porous body shown in Patent Document 1, has been cleared. Further, in the moisturizing method using the solid rubber, the moisturizing volume is controlled by changing of the nipping pressure, and by changing the roughness of the surface of the moisturizing roller.

However, it is to be understood that the moisturizing method, using the solid rubber, includes problems, as listed below.

In order to apply sufficient water volume and to make the recording sheet to be uniformly moisturized, it is necessary that the nipping width of the moisturizing nip portion, formed of paired rollers, is configured to be greater than a predetermined value. Further, as a rubber member to form the moisturizing roller which may deform due to the pressure, a rubber member is used, which includes plasticizer, and exhibits adequate elasticity.

However, it has been understood that problems, listed below, are generated in a moisturizing method using the solid rubber, including the plasticizer. Those problems will now be explained, while referring to FIGS. 1-3.

When the moisturizing roller is rotated for long hours, the plasticizer included in the rubber discharges from a portion of the rubber, being in contact with the recording sheet. Accordingly, the moisturizing roller is deformed, in more detail, the diameter of the moisturizing roller decreases, by which the recording sheet is unevenly moisturized.

FIG. 1 shows shrinkage of the diameter of moisturizing rollers WA and WB. Concerning sheet-non-conveying area SA, the diameters of paired moisturizing rollers WA and WB are constant as shown by DA. Concerning sheet-conveying area SB, due to the discharge of the plasticizer, the diameters of moisturizing rollers WA and WB shrink as shown by DB.

On the other hand, during the moisturizing process onto recording sheet S, the phenomena shown in FIG. 2 occur.

On paired water supplying rollers WC, water is supplied from a water bowl (which is not illustrated) to said rollers WC, whereby water layer WL1 is formed, further, water layer WL2 is formed by paired controlling members WD. Water layer WL2 shifts from water supplying roller WC to moisturizing rollers WA and WB, whereby pooled water WM is generated under the contacting portion of paired moisturizing pollen WA and WB.

The moisturizing device is designed so that the quantity of water to be held by pooled water WM is controlled to be very little, during the normal moisturizing operation. Concerning moisturizing rollers WA and WB, having fine asperities on their surfaces, the nipping pressure is determined so that paired moisturizing rollers WA and WB can come into contact with each other due to pressure, while said fine asperities of moisturizing rollers WA and WB are not flattened. By the nipping pressure, the water is supported in concave portions of the asperities of the surfaces. When recording sheet S is conveyed as shown by an arrow, but is not yet introduced into the moisturizing nip portion, water layer WL2 is not blocked by the moisturizing nip portion, but passes through said portion, whereby pooled water WM is not created, or even though it is created, a very small quantity of water is held in pooled water WM.

Recording sheets S are introduced in a predetermined interval into the moisturizing nip portion formed between paired moisturizing pollen WA and WB, so that recording sheets S are moisturized uniformly.

However, in FIG. 2, when the quantity of water in pooled water WM is relatively large, a large quantity of water is applied from pooled water WM onto the leading portion of each recording sheet, whereby excess moisturizing is adversely carried out on the leading portion of each recording sheet S, which results in un-uniformed moisturizing.

By adequately determining the pressure of pressure applying section PM, as detailed above, it is possible to control un-uniformed moisturizing, and to carry out uniform moisturizing operation on recording sheet S.

However as detailed above, if diameter DA of sheet-non-conveying area SA differs from diameter DB of sheet conveying area SB, and even though the pressure of pressure applying section PM is controlled, the pressure is largely concentrated onto sheet-non-conveying area SA, which results in an increase of the nipping pressure on said area SA. Said concentration occurs to be more marked between sheet intervals, on which no sheet S passes through the moisturizing nip portion. That is, in a condition that sheet S is passing between moisturizing pollen WA and WB, recording sheet S fills in the difference between diameters DA and DB, whereby the concentration of the pressure onto sheet-non-conveying area SA is reduced. However, during the sheet intervals in which no sheet S is passing between moisturizing rollers WA and WB, nothing fills in the difference between diameters DA and DB, whereby the pressure, applied by pressure applying section PM, is concentrated onto sheet-non-conveying area SA. As a result, water layer WL2 cannot pass through the nipping area on sheet-non-conveying area SA, so that large pooled water WM is formed, that is, a large quantity of water is held in pooled water WM. Pooled water WM, formed on sheet-non-conveying area SA, is shown in FIG. 3.

During the sheet interval in which no sheet S is passing between moisturizing rollers WA and WB, pooled water WM shifts to sheet-conveying area SB as shown by the arrows in FIG. 3, and said pooled water WM adheres onto recording sheet S, which is introduced after the above sheet interval. As a result, a large quantity of water is applied onto the leading portion of recording sheet S, and un-uniformed moisturizing is generated. Due to this, recording sheet S is deformed and undulated.

In case that the moisturizing rollers, which are formed of solid rubber including plasticizers, are used, the above detailed problem occurs, due to the reduction of the diameter, which is caused by the discharge of the plasticizer.

An object of the present invention is to offer a sheet moisturizing device, exhibiting high durability and carrying out uniform moisturizing onto the recording sheet, and an image forming system including the same device, by solving the above detailed problems in a conventional sheet moisturizing device.

### SUMMARY OF THE INVENTION

To achieve at least one of the abovementioned objects, a sheet moisturizing device reflecting one aspect of the present invention has paired moisturizing rollers, which are configured to be in contact with each other and to apply liquids onto a recording sheet while nipping to convey the recording sheet, wherein the paired moisturizing rollers are configured to include a mandrel, and a moisturizing layer which is formed on the mandrel and is formed of a porous body carrying independent cells which are not interconnected with each other, and a liquid supplying member which is configured to supply the liquid onto surfaces of the paired moisturizing rollers.

Hereinafter, the porous body carrying independent cells is referred to as an “independent cell porous body”.

An image forming system reflecting another aspect of the present invention has the above detailed sheet moisturizing device, an image forming apparatus which is configured to form an image on the recording sheet, and to convey the recording sheet to the sheet moisturizing device.

### BRIEF DESCRIPTIONS OF THE DRAWINGS

Embodiments will now be detailed, by way of example only, with reference to the accompanying drawings which are meant to be exemplary, not limiting, and wherein like embodiments are numbered alike in the several figures, in which:

FIG. 1 is a drawing to show the shrinkage of the diameters of the paired moisturizing rollers;

FIG. 2 is a drawing to detail the moisturizing process;

FIG. 3 is a drawing to show the pooled water which is formed at the sheet-non-conveying area;

FIG. 4 is an overall drawing to show the image forming system relating to the embodiment of the present invention;

FIG. 5 is an overall drawing to show a sheet post-finishing device relating to the embodiment of the present invention;

FIG. 6 is a drawing to show the structure of the sheet moisturizing device;

FIG. 7 is a perspective drawing to show the water bowl;

FIG. 8 is a graph to show the moisturizing characteristics, when a large number of recording sheets are moisturized; and

FIG. 9 is a graph to show the change of diameter of the moisturizing roller, when a large number of recording sheets have been moisturized.

### DETAILED DESCRIPTIONS OF THE PREFERRED EMBODIMENT

The present invention will now be detailed by using the embodiments, however, the present invention is not limited to these embodiments.

[Image Forming System]

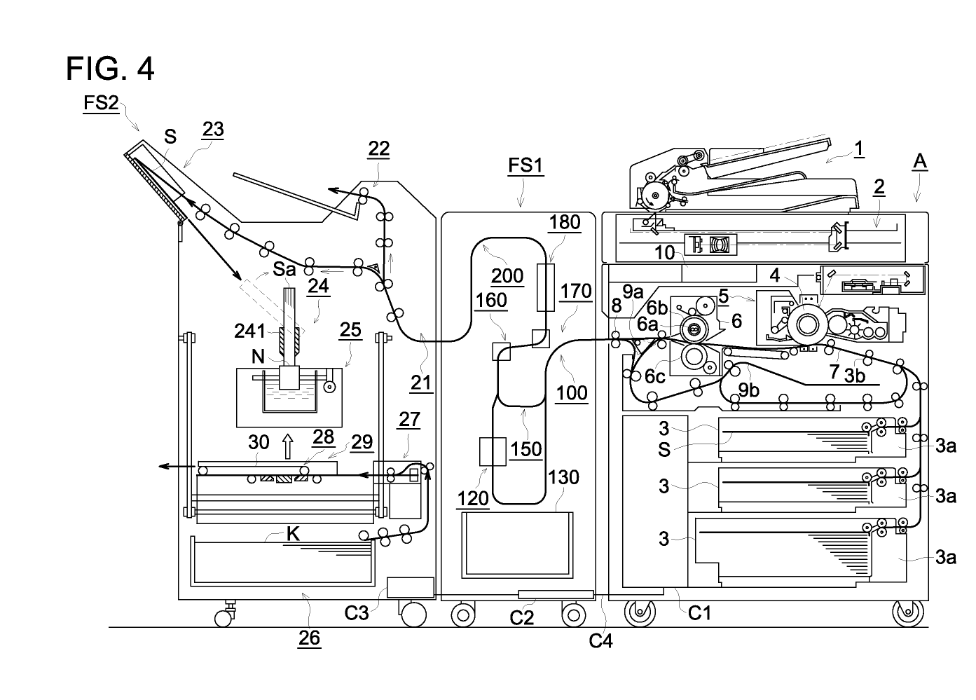

FIG. 4 is an overall drawing to show the image forming system relating to the embodiment of the present invention, wherein the image forming system is structured of image forming apparatus A, and sheet post-finishing devices FS1 and FS2.

Image forming apparatus A is structured of automatic document feeding device 1 and image reading section 2 on an upper section of said apparatus, and is also structured of a printer section on a lower section of said apparatus.

In the printer section, numeral 3 represents a sheet accommodating section for accommodating sheets S. In printer engine 5 for forming a toner image on photosensitive body 4 by an electro-photographic process for charging and exposing photo sensitive body 4, after an image has been formed on recording sheet S, said image is fixed on recording sheet S by fixing device 6. In fixing device 6, a fixing nip portion, for conveying sheet S, is formed of heating roller 6b, including heat source 6a, and pressure applying roller 6c, whereby sheet S is heated and pressed while being conveyed, so that the toner is melted and the image is fixed on recording sheet S.

Recording sheet S is conveyed from sheet accommodating section 3 by first sheet supplying section 3a, after said recording sheet S is temporarily stopped at second sheet supplying section 3b, said recording sheet S is conveyed and image formation is conducted on said recording sheet S. Said recording sheet S, carrying the formed image, is then ejected through a sheet outlet by sheet ejecting rollers 8.

As sheet conveying paths for conveying recording sheet S, provided are sheet supplying path 7, which is from recording sheet accommodating section 3 to printer engine 5, and sheet conveying path 9a and sheet reversing path 9b, which are from printer engine 5 to the sheet outlet, through fixing device 6 and sheet ejecting rollers 8.

As sheet ejection modes, provided are a face-down ejection mode of a single surface printed sheet, a face-up ejection mode of a single surface printed sheet, and an ejection mode of both surfaces printed sheet. In said face-down ejection mode, after an image is formed on a single surface of recording sheet S, said recording sheet S is processed by fixing device 6, subsequently, said recording sheet S is reversed by a sheet reversing process, and is then ejected by sheet ejecting rollers 8.

In said face-up ejection mode, after an image is formed on a single surface of recording sheet S, said recording sheet S is conveyed through conveying path 9a, and directly ejected by sheet ejecting rollers 8.

In the both-surface ejection mode, after an image is formed on one surface of recording sheet S, said recording sheet S is processed by fixing device 6, and said recording sheet S is conveyed downward to enter sheet reversing path 9b, and is reversed, then said recording sheet S is again conveyed to sheet supplying path 7.

Subsequently, an image is formed on the reverse surface of said recording sheet S by printer engine 5. Recording sheet S, carrying images on both surfaces, is processed by sheet fixing device 6, and is ejected by sheet ejecting rollers 8.

Control section C1 is configured to control the image formation in image forming apparatus A, and the whole image forming system. Various operations, for setting the operation modes in image forming apparatus A, and for setting outputting modes in sheet post-finishing devices FS1 and FS2, can be conducted on operation section 10.

Control section C1 of image forming apparatus A is electrically connected to control section C2 of sheet post-finishing device FS1, and control section C3 of sheet post-finishing device FS2, via communication section C4.

Control section C1 controls the image forming process in image forming apparatus A, as well as the total image forming system. Control section C2 controls sheet post-finishing device FS1, and control section C3 controls sheet post-finishing device FS2. Control sections C2 and C3 conduct various controls, based on commands and information, sent from control section C1, and send conditions of sheet post-finishing devices FS1 and FS2 to control section C1. A control section, structured of control sections C1, C2 and C3, controls the total image forming system.

Recording sheet S, ejected from image forming apparatus A, is conveyed to sheet post-finishing device FS2, through sheet post-finishing device FS1.

Sheet post-finishing device FS1 is structured of first inlet conveyance section 100 which is configured to receive and convey recording sheet S ejected from image forming apparatus A, sheet moisturizing device 120, which is configured to apply water to recording sheet S, second inlet conveyance section 150 which is configured to receive and convey recording sheet S ejected from image forming apparatus A, first de-curling section 160, second de-curling section 170, third de-curling section 180, and sheet ejecting section 200 which is configured to deliver recording sheet S to sheet post-finishing device FS2.

Sheet post-finishing device FS is configured to conduct various post-finishing processes onto sheet S, ejected from image forming apparatus A. An example shown in FIG. 4 is a glue applying book-making machine, it is also possible to install a punching and folding device, a side-stitching device, a saddle-stitching device, and a cutting device.

The paste applying book-making machine is structured of sheet introducing section 21, sheet ejecting section 22, sheet-bundle accommodating section 23, sheet-bundle conveying section 24, paste coating section 25, coversheet supplying section 26, coversheet cutting section 27, coversheet attaching section (book wrapping section) 28, and aligning section 29.

After sheet S is introduced into sheet introducing section 21, sheet S is placed on sheet-bundle accommodating section 23. Sheet S is individually conveyed obliquely downward, whereby sheet S is supported by supporting section 241 of sheet-bundle conveying section 24. While supporting sheet-bundle Sa, supporting section 241 is controlled to swing and stop at a predetermined position, so that the spine of the sheet-bundle (being the portion where paste is applied) faces downward. Paste coating section 25 applies the paste onto the spine of sheet-bundle Sa.

Coversheet K, accommodated in coversheet supplying section 26, is conveyed to coversheet attaching section 28 through coversheet cutting section 27, whereby the trailing edge of coversheet K is cut by coversheet cutting section 27, to be a predetermined length. The cutting length of coversheet K is determined to be a length including the lengths of two sheets in the conveying direction of recording sheet S, as well as the width of the spine of sheet-bundle Sa.

Coversheet attaching section 28 receives coversheet K from coversheet supplying section 26, and sends it at a predetermined position, where coversheet K is stopped. Aligning section 29 aligns coversheet K in the width direction. Coversheet K is pressed against paste applied surface N of sheet-bundle Sa, by coversheet attaching section 28.

A pressure applying member, which faces the spine of sheet-bundle Sa, is moved downward, and paired folding members, each of which is symmetrically arranged above coversheet attaching section 28, are moved, so that coversheet K is folded along the edges of glue applied surface N, whereby sheet-bundle Sa, covered with coversheet K, is produced.

After cover sheet K has been folded, coversheet attaching section 28 is moved away downward. Ejection belt 30, which has moved away with aligning section 29, to the outer side of coversheet K in the width direction, is moved downward to the inner side, in the width direction, of sheet-bundle Sa, and ejection belt 30 then stops. Subsequently, supporting section 241 is deactivated, so that sheet-bundle Sa is moved downward, and stops, when a lower portion of the spine of sheet-bundle Sa comes into contact with the upper surface of ejection belt 30. Rotating ejection belt 30 ejects a booklet, being sheet-bundle K covered with coversheet K.

[Sheet Post-Finishing Device]

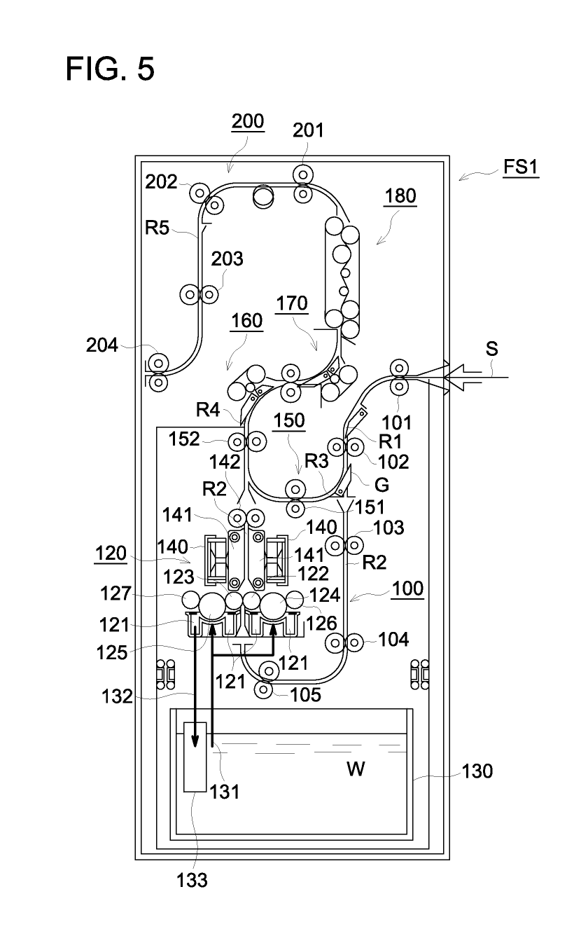

FIG. 5 is an overall drawing to show sheet post-finishing device FS1, relating to the embodiment of the present invention.

First inlet conveyance section includes conveying path R1, sheet moisturizing device 120 includes conveying path R2, second inlet conveyance section includes conveying path R3, first-third de-curling sections 160, 170 and 180 include conveying path R4, and sheet ejecting section 200 includes conveying path R5.

As shown in FIG. 5, conveying paths R1-R5 are formed of plural guide members.

A portion of conveying path R1 is shared by first inlet conveyance section 100 and second inlet conveyance section 150.

After recording sheet S is conveyed into sheet post-finishing device FS1, said sheet S is guided by switching gate G, to go through first inlet conveyance section 100, second inlet conveyance section 150, first-third de-curling sections 160, 170 and 180, and sheet ejecting section 200, to be ejected, or to go through first inlet conveyance section 100, sheet moisturizing device 120, second inlet conveyance section 150, first-third de-curling sections 160, 170 and 180, and sheet ejecting section 200, to be ejected.

In first inlet conveyance section 100, recording sheet S is conveyed by conveying rollers 101-105 to sheet moisturizing device 120.

In sheet moisturizing device 120, recording sheet S is conveyed by moisturizing rollers 122 and 123, and paired conveying rollers 142.

In second inlet conveyance section 150, recording sheet S is conveyed by conveying rollers 101, 102, 151 and 152.

In sheet ejecting section 200, recording sheet S is conveyed by conveying rollers 201-204, and ejected to the next device.

The moisturizing section in sheet post-finishing device FS1 will be detailed below.

[Sheet Moisturizing Device]

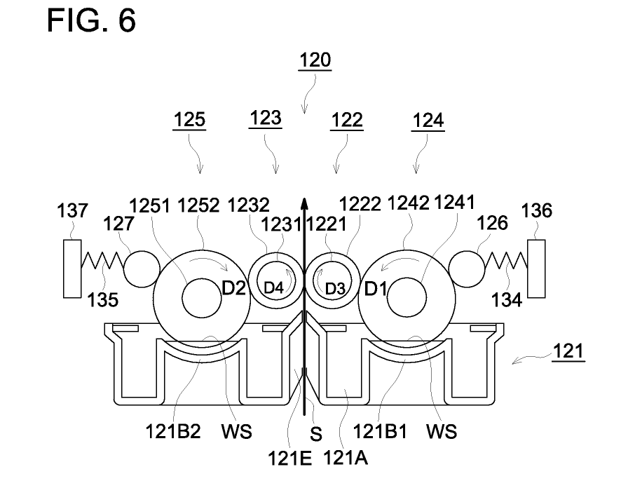

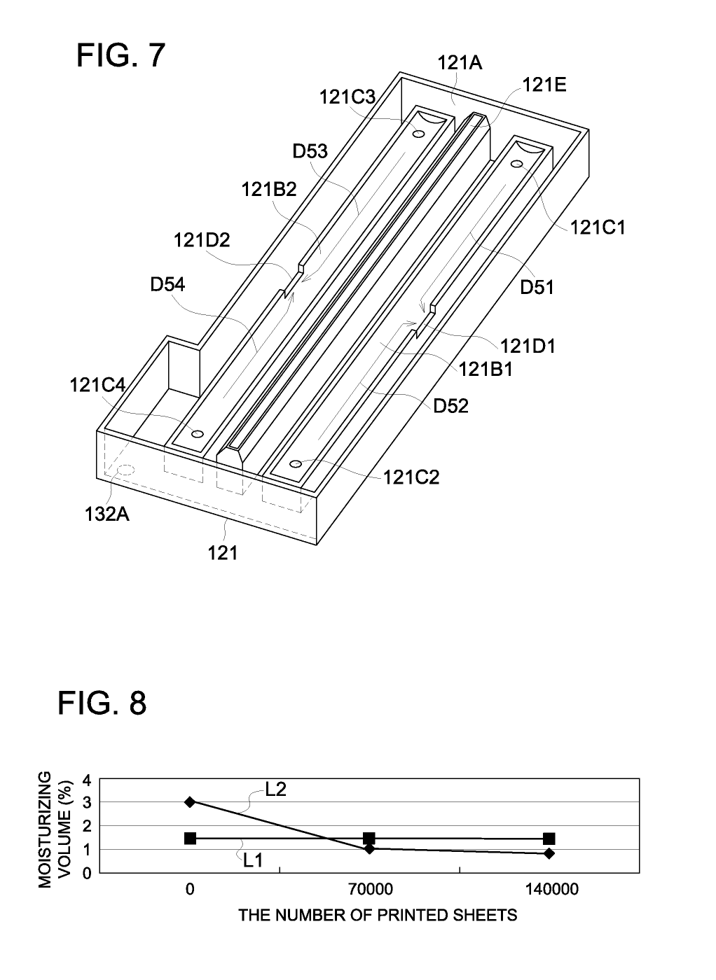

The structure and the function of sheet moisturizing device 120 will be detailed, while referring to FIGS. 6 and 7. FIG. 6 is a front cross-sectional view of sheet moisturizing device 120, and FIG. 7 is a perspective view of water bowl 121.

Water bowl 121 includes water tank 121A, whose width is slightly greater than the maximum width of recording sheet S (being the sheet length measured perpendicular to the sheet conveying direction)

Water supplying bowls 121B1 and 121B2 are arranged side by side in water bowl 121.

Water supplying bowls 121B1 and 121B2 represent bowls to keep the water level at a higher position than water tank 121A.

The water overflows from water supplying bowls 121B1 and 121B2, and falls into water tank 121A.

Clearance 121E, through which recording sheet S is passed, is arranged at the center of water bowl 121.

As shown in FIG. 7, water supplying bowls 121B1 and 121B2, and clearance 121E are formed like islands within water tank 121A.

Each of water supplying bowls 121B1 and 121B2 has a circular inner periphery surface which corresponds to the outer periphery surfaces of water supplying rollers 124 and 125, respectively.

Water W is supplied to water supplying bowls 121B1 and 121B2 through water tube 131 (see FIG. 5), and water W overflows through water drains 121D1 and 121D2, so that water level WS is held at a predetermined height.

Antifungal agent may be included in water W as an accessory component. That is, the moisturizing operation against recording sheet S is conducted by applying not only water W, but also water W including the accessory component. Accordingly, liquid in the present invention represents the water or the water including the accessory component.

In FIG. 6, above water supplying bowls 121B1 and 121B2, water supplying rollers 124 and 125 are arranged to be separated at a predetermined clearance, from the inner peripheries of water supplying bowls 121B1 and 121B2. Further, lower portions of water supplying rollers 124 and 125 are immersed in water W, accommodated in water supplying bowls 121B1 and 121B2.

Water supplying rollers 124 and 125, serving as water supplying members, include a metallic mandrel respectively, on which rubber water supplying layers 1242 and 1252 are formed as rubber rollers. Water supplying roller 124 rotates counterclockwise as shown by arrow D1, and water supplying roller 125 rotates clockwise as shown by arrow D2.

Moisturizing roller 122 is arranged to be in contact with water supplying roller 124, while moisturizing roller 123 is arranged to be in contact with water supplying roller 125. Moisturizing roller 122 and moisturizing roller 123 are arranged to be in contact with each other.

Moisturizing roller 122 rotates clockwise as shown by arrow D3, while moisturizing roller 123 rotates counterclockwise as shown by arrow D4, whereby both rollers 122 and 123 nip recording sheet S and convey recording sheet S upward as shown in FIG. 6.

Because either moisturizing roller 122 or 123 is configured to rotate as a driving roller by a driving source (which is not illustrated), so that another moisturizing roller and water supplying rollers 124 and 125 rotate as driven rollers.

Control member 126 is in contact with water supplying roller 124, while control member 127 is in contact with water supplying roller 125.

Each of control members 126 and 127 is formed of a metallic cylindrical roller, which is driven by water supplying rollers 124 and 125, respectively. Control members 126 and 127 are configured to press against moisturizing rollers 124 and 125, by the pressing forces generated by springs 134 and 135, respectively. Due to these constructions, moisturizing roller 122 and moisturizing roller 123 are configured to press against each other by the elasticity of the rubber of said rollers, and by the elasticity of springs 134 and 135 to urge control members 126 and 127, respectively. Accordingly, moisturizing rollers 122 and 123 nip recording sheet S and convey recording sheet S upward, while water W is applied onto recording sheet S.

In FIG. 5, numeral 130 represents a water container, numeral 131 represents a water supplying tube, numeral 132 represents a drain tube, and numeral 133 represents a filter.

By a pump, which is not illustrated, water W is supplied from water container 130 to water supplying bowls 121B1 and 121B2 of water bowl 121 through water supplying tube 131, and is returned to water container 130 from water bowl 121 through drain tube 132.

Water W is supplied from inflow ports 121C1-121C4 through water supplying tube 131, water W flows as shown by arrows D51-D54, and flows out through water drains 121D1 and 121D2.

While water W is supplied to recording sheet S, foreign particles, such as paper powder, are included in water W. Said foreign particles are filtered out by filter 133. Water W is circulated between water container 130 and water bowl 121.

Water W is supplied to recording sheet S as follows.

Recording sheet S is introduced into sheet moisturizing device 120 by paired conveying rollers 105, subsequently recording sheet S is conveyed to pass through clearance 121E, and is conveyed by moisturizing rollers 122 and 123.

Water W is layered onto the periphery surfaces of moisturizing rollers 122 and 123, so that water W is continuously supplied to recording sheet S, during the conveyance.

Water W is evenly layered on the periphery surfaces of water supplying rollers 124 and 125, and is further evened by control members 126 and 127.

While water W is supplied to recording sheet S, the foreign particles, such as the paper powder, are adhered onto moisturizing rollers 122 and 123, and are included within water W. The foreign particles are filtered out by filter 133.

[Moisturizing Roller]

As the moisturizing rollers which supply water W to recording sheet S and moisturize recording sheet S, used are moisturizing roller 122, carrying moisturizing layer 1222 formed on metallic mandrel 1221, and moisturizing roller 123, carrying moisturizing layer 1232 formed on metallic mandrel 1232.

Each of moisturizing layers 1222 and 1232 is formed of a porous body, carrying the independent cells, wherein the independent cells are not interconnected with each other.

Since the independent cell porous body exhibits appropriate elasticity, moisturizing layers 1222 and 1232, which are configured to be in pressure contact with each other to form a moisturizing nipping area, can be formed of the independent cell porous body, whereby the moisturizing nip can be formed to have an adequate nipping width to conduct stable moisturizing onto the recording sheet.

In order to create the nipping area having a predetermined width by using paired rollers being pressure contact with each other, the paired rollers are required to elastically change their shape by the pressure. Accordingly, in the conventional technology, as shown in Patent Document 2, a rubber roller, including the plasticizing agent, has been used.

To compare the above, since the paired rollers, having the moisturizing layer formed of the independent cell porous body, do not include the plasticizing agent, but are elastic, so that said rollers can change their shapes by the pressure and form the predetermined nipping area.

Further, concerning moisturizing layers 1222 and 1232, a large number of cells have been independently formed in said layer, that is, the cells have been formed to be separated with each other, whereby water W, supplied to the rollers, are held on the surfaces of moisturizing layers 1222 and 1232, and an extremely low volume of water can enter the inside of moisturizing layers 1222 and 1232, formed of the independent cell porous body. By the same reason, the foreign particles, adhered on the surfaces of moisturizing layers 1222 and 1232, cannot enter the inside of the layers. Accordingly, the foreign particles, adhered on the surfaces of moisturizing layers 1222 and 1232, can be easily washed by water W in water supplying bowls 121B1 and 121B2 during normal operations, whereby the moisturizing operation can be effectively conducted for a prolonged period.

FIG. 8 shows the moisturizing characteristics in a case in which a continuous cell porous body is used for the moisturizing layer of the moisturizing roller, and a case in which the independent cell porous body is used for the moisturizing layer of the moisturizing roller.

As a material for forming moisturizing layers 1222 and 1232, hydrophilic celled urethane rubber is used.

In FIG. 8, line L1 shows the moisturizing characteristic of the moisturizing layer, formed of the independent cell porous body, of the moisturizing roller, while line L2 shows the moisturizing characteristic of the moisturizing layer, formed of the continuous cell porous body, of the moisturizing roller. As shown in FIG. 8, in the case in which the continuous cell porous body is used for the moisturizing layer of the moisturizing roller, A4-size recording sheets are conveyed in the direction in which the longer edge of the recording sheet is parallel to the sheet conveying direction, the moisturizing characteristics deteriorate drastically, until about 70,000 sheets have been conveyed. However, in the case in which the independent cell porous body is used for the moisturizing layer of the moisturizing roller, the moisturizing characteristics do not change, until about 14,000 sheets have been conveyed.

Since each of moisturizing layers 1222 and 1232 is the porous body, minute asperities exist on their surfaces. Due to these minute asperities, the surface area of the rollers increases, whereby sufficient volume of water is held on the surface of moisturizing layers 1222 and 1232. As a result, a sufficient volume of water is evenly applied onto recording sheet S, during the high speed moisturizing process.

As moisturizing layers 1222 and 1232, following members are preferably used.

(1) Moisturizing layers 1222 and 1232 are preferably formed of the independent cell porous rubber, said layers are more preferably formed of the hydrophilic celled urethane rubber, and are most preferably formed of an ester type urethane rubber, exhibiting high abrasion resistance.

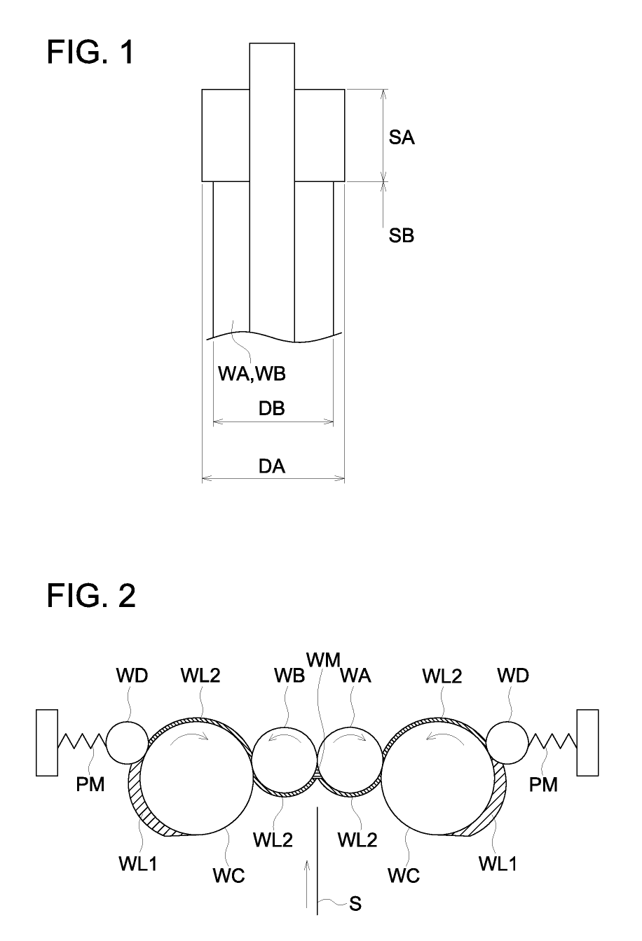

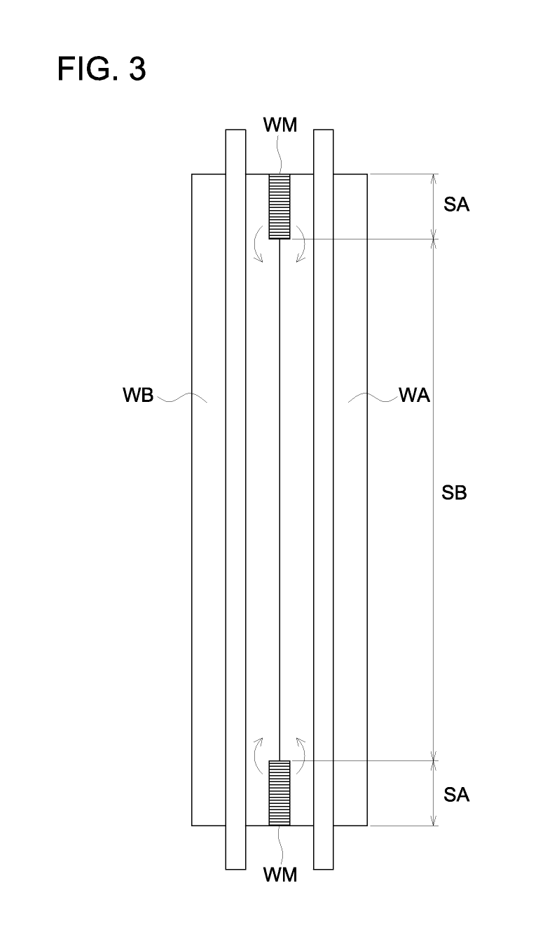

(2) Moisturizing layers 1222 and 1232 do not include a plasticizing agent, being most preferable, and even if said layers include the plasticizing agent, the contained amount is less than 10 percent by mass, being preferable. Adverse reduction of the diameter of moisturizing rollers 122 and 123 is effectively controlled, during the long working time, by the reduction of the contained amount of the plasticizing agent. As detailed above while referring to FIGS. 1-3, the plasticizing agent tends to discharge from the rollers in the sheet-conveying area during the long working time, whereby the diameter of the rollers reduces, which results in uneven moisturizing. However, due to the reduction of the contained amount of the plasticizing agent, the reductions of the diameter of the rollers are effectively controlled, and the uneven moisturizing is prevented.

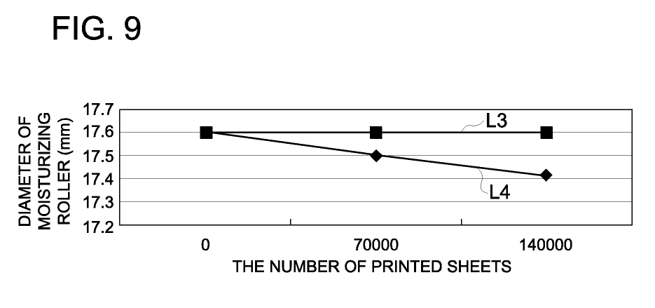

FIG. 9 shows the reductions of the diameters of the moisturizing rollers, in a case in which the moisturizing layer, containing no plasticizing agent in the independent cell porous body, of the moisturizing roller, is used, and in a case in which the moisturizing layer of the moisturizing roller is formed of solid rubber, having the plasticizing agent, exhibiting 24 percent by mass.

In addition, the independent cell porous body in the above case is the hydrophilic celled urethane rubber, while as the solid rubber, hydrophidic NBR is used (which is nitrile rubber).

Line 3 shows the change of the diameter of the moisturizing roller, having the moisturizing layer, formed of the independent cell porous body having no plasticizing agent, and line 4 shows the change of the diameter of the moisturizing roller, having the moisturizing layer, formed of the solid rubber containing the plasticizing agent.

In addition, the initial thickness of the moisturizing layer is 2.8 mm.

In the case in which the moisturizing roller, having the moisturizing layer formed of the independent cell porous body, is used, the diameter does not change until about 14,000 sheet have been conveyed. However, in the case in which the moisturizing roller, having the moisturizing layer formed of solid rubber containing the plasticizing agent, is used, the diameter of the moisturizing roller linearly decreased, while the number of the moisturized recording sheets increases.

Due to the decrease of the diameter of the moisturizing roller, the uneven moisturizing adversely occurs, so that when about 70,000 sheets have been moisturized, the recording sheets begin to undulate, and when about 140,000 sheets have been moisturized, undulation of the recording sheets became serious.

(3) The average diameter of the cells in the independent cell porous body is preferably 30-70 μm. If the average diameter of the cells is less than 30 μm, the volume of water, held in moisturizing layers 1222 and 1232, becomes less, so that the recording sheets tend to curl due to moisturizing shortage. If the average diameter of the cells is greater than 70 μm, the volume of water, held in moisturizing layers 1222 and 1232, becomes too great, so that the recording sheets tend to curl, due to excessive moisturizing.

[Water Supplying Member]

If a water supplying member can sufficiently supply water to moisturizing rollers 122 and 123, the water supplying member is not limited to a specific member. Paired water supplying rollers 124 and 125, each of which is configured to individually come into contact with moisturizing rollers 122 and 123, are preferably used. Paired water supplying rollers 124 and 125 have water supplying layers 1242 and 1252, each of which is formed of rubber.

In order to stably supply water to moisturizing rollers 122 and 123, a water supplying nip portion, having a predetermined nipping width, is preferably formed. Accordingly, water supplying layers 1242 and 1252 are preferably formed of a rubber, exhibiting a hardness of 20-60 degrees (according to JIS A).

As a rubber member to structure water supplying layers 1242 and 1252, hydrophilic NBR (being nitrile rubber) or a hydrophilic urethane rubber is preferable.

Further, the surface asperity of water supplying layers 1242 and 1252 is preferably 10-30 μm. By said surface asperity, a sufficient volume of water is evenly held on the surfaces of water supplying rollers 124 and 125, whereby a sufficient volume of water can be stably supplied onto moisturizing rollers 122 and 123.

The thickness of water supplying layers 1242 and 1252 is preferably 2.0-12.0 mm.

To supply water to the recording sheet, the paired moisturizing rollers are structured to have the independent cell porous body in the present embodiment.

Due to this structure, it is possible to realize a sheet moisturizing device, exhibiting high endurance, which can evenly moisturize the recording sheet, and an image forming system using the same.

What is claimed is:

1. A sheet moisturizing device comprising:
paired moisturizing rollers, which are configured to be in contact with each other and to apply liquids onto a recording sheet while nipping to convey the recording sheet, wherein the paired moisturizing rollers are configured to include
a mandrel; and
a moisturizing layer which is formed on the mandrel and is formed of a porous body carrying independent cells which are not interconnected with each other; and
a liquid supplying member which is configured to supply the liquid onto surfaces of the paired moisturizing rollers.

2. The sheet moisturizing device of claim 1, wherein the porous body carrying the independent cells is formed of an urethane rubber.

3. The sheet moisturizing device of claim 2, wherein the urethane rubber comprises an ester type urethane rubber.

4. The sheet moisturizing device of claim 1, wherein an average diameter of the independent cells is 30-70 μm.

5. The sheet moisturizing device of claim 1, wherein the liquid supplying member includes liquid supplying rollers which are configured to be in contact with the paired moisturizing rollers.

6. The sheet moisturizing device of claim 1, wherein in the porous body carrying a large number of the independent cells, the cells independently exist not to be interconnected with each other.

7. An image forming system, comprising:
a sheet moisturizing device comprising:
paired moisturizing rollers, which are configured to be in contact with each other and to apply liquids onto a recording sheet while nipping to convey the recording sheet, wherein the paired moisturizing rollers are configured to include
a mandrel; and
a moisturizing layer which is formed on the mandrel and is formed of a porous body carrying independent cells which are not interconnected with each other; and
a liquid supplying member which is configured to supply the liquid onto surfaces of the paired moisturizing rollers, and
an image forming apparatus which is configured to form an image on the recording sheet, and to convey the recording sheet to the sheet moisturizing device.

8. The image forming system of claim 7, wherein the porous body carrying the independent cells is formed of an urethane rubber.

9. The image forming system of claim 8, wherein the urethane rubber comprises an ester type urethane rubber.

10. The image forming system of claim 7, wherein an average diameter of the independent cells is 30-70 μm.

11. The image forming system of claim 7, wherein the liquid supplying member includes liquid supplying rollers which are configured to be in contact with the paired moisturizing rollers.

12. The image forming system 7, wherein in the porous body carrying a large number of the independent cells, the cells independently exist not to be interconnected with each other.
